(19) United States
(12) Patent Application Publication
(10) Pub. No.: US 2017/0042353 A1
(43) Pub. Date: Feb. 16, 2017

(54) Composite Material, Associated Item of Dishware and Associated Production Processes

(71) Applicant: MEALPLAK, Gemenos (FR)

(72) Inventor: Mathieu Tambon, Allauch (FR)

(73) Assignee: Mealplak, Gemenos (FR)

(21) Appl. No.: 14/654,802

(22) PCT Filed: Feb. 20, 2014
(86) PCT No.: PCT/FR2014/050354

§ 371 Date: Oct. 26, 2016

(30) Foreign Application Priority Data
Dec. 20, 2012 (FR) 1262420

(51) Int. Cl. A47G 19/02; B32B 27/38; B32B 27/08; B32B 27/30; A47G 23/03; A47G 23/06

(52) U.S. Cl. CPC A47G 19/02; A47G 23/03; A47G 23/06; B32B 27/08; B32B 27/308; B32B 27/38; B32B 2307/402; B32B 2307/414; B32B 2307/41; B32B 2307/744; B32B 2439/70; B32B 2451/00

(57) ABSTRACT

The invention concerns a dishware item for containing food, the item being formed of two rigid layers: a first upper layer presenting a face including one or several hollow form(s) for receiving and retaining the food and a second lower layer presenting an underside forming a base, wherein the first layer has a thickness greater than or equal to 3 millimeters and is constituted essentially of a food-grade epoxy resin or a food-grade methyl polymethacrylate, the resin or polymethacrylate being colorless and translucent; the second layer has a thickness greater than or equal to 1 millimeter, still smaller than the thickness of the first layer, and is constituted essentially of an opaque epoxy resin; and the two layers are welded to each other so as to obtain a one-piece item.

### TECHNICAL FIELD

The invention relates in particular to a dishware item intended to contain food, as well as its manufacturing method.

It concerns the technical field of tableware and more particularly those related to dishes, bowls, plates, trays or the same. Nonetheless, the invention would not be limited to this sole field: it also concerns other fields, such as, as non-limiting examples, display stands in the jewelry field, toys, decorative objects, in particular lamps.

### BACKGROUND

In general, dishware items are made of porcelain, ceramic, wood, slate or faience. However, these materials present numerous drawbacks:
they are relatively fragile, that is to say barely resistant to impacts and to high temperatures, whether the latter are very high or very low, and a dinner service is often chipped, scratched or broken after a few years of use;
some are not easy to clean, since they do not go in a dishwasher;
they do not comply with all the requirements of food standards;
they are not easily customizable.

There are known, from the documents US 2002/0079317 (SCOTT) or FR 2.954.901 (ANNIKIDS), dishware items constituted by two rigid portions: an upper portion presenting a surface for receiving the food and a lower portion presenting an underside forming a base. These two portions are removable so that it is possible to place, therebetween, a removable decorative sheet visible by transparency. These two portions may be made of plastic, which makes them less fragile than dishware items made of porcelain, ceramic, wood, slate or faience.

Nonetheless, this type of product is relatively complex to manufacture, assemble and maintain. Furthermore, holding the two lower and upper portions to each other is deteriorated over successive uses, since the hooking means of said lower and upper portions are damaged after repeated uses.

Moreover, the decorative objects, such as display stands or lamps, are generally heavy, barely aesthetic and customizable.

Furthermore, the materials constituting the toys are sometimes toxic or chip easily, thereby presenting hazards for the health and safety of children.

### BRIEF SUMMARY

In the entire document, the term <<decorative object >> refers to any object whose purpose is not food.

The invention allows addressing all or part of the drawbacks raised by the known solutions.

Among the numerous advantages brought by a dishware item according to the invention, mention may be made to the fact that this item allows:
having a non-toxic composite material which can be used in numerous fields;
having a composite material which resists scratches and/or impacts and which is barely alterable by successive uses;
having a dishware item the design of which allows obtaining a particularly original and attractive visual effect.

Another objective of the invention is to propose methods for manufacturing a composite material, more particularly a dishware item, which are simpler and quicker to implement. These manufacturing methods are unique and allow realizing a wide range of objects, such as, as non-limiting examples, dishware items, display stands used more particularly in the jewelry field, toys, decorative objects, in particular lamps.

To this end, there is provided in particular a composite material including two rigid layers, in particular an upper layer presenting a face and a lower layer presenting an underside forming a base. According to a preferred embodiment:
the upper layer has a thickness greater than or equal to three millimeters and is constituted essentially of a food-grade epoxy resin or a food-grade methyl polymethacrylate, said resin or said polymethacrylate being colorless and translucent;
the lower layer has a thickness greater than or equal to one millimeter, still smaller than the thickness of the upper layer, and is constituted essentially of an opaque epoxy resin;
the two layers cooperate with each other and form a one-piece item.

Alternatively or complementarily, the opaque epoxy resin may be colored.

Advantageously, the face of the upper layer may be an anti-slip surface.

Preferably, the upper layer may have a thickness greater than or equal to three millimeters and the lower layer may have a thickness smaller than two millimeters.

In order to create a levitation effect, the upper layer may have a refractive index comprised between 1.3 and 1.6.

In order to enable a customization of the composite material, an intermediate layer including decorative elements may be inserted between the lower and upper layers.

According to a second object, the invention concerns a dishware item for containing food. Advantageously, said item is developed from a composite material in accordance with the invention.

The invention further concerns any decorative object, developed from a composite material according to the invention.

According to another object, the invention concerns a method for manufacturing a dishware item in accordance with the invention. Advantageously, said method comprises the steps consisting in:
cutting, according to a desired contour, a rigid plate constituted essentially of a food-grade epoxy resin or a food-grade methyl polymethacrylate, said plate having a thickness greater than or equal to three millimeters and being colorless and translucent;
laying the cut plate on a rigid support and applying a formwork tightly against the contour of said plate, said formwork presenting borders which exceed the free surface of said plate;
casting, on the free surface of the cut plate, and over a thickness greater than or equal to one millimeter, an unpolymerized fluid layer of a colored and opaque epoxy resin;
leaving the layer of epoxy resin polymerize until obtaining a one-piece item formed of a rigid layer of epoxy resin welded to the rigid plate.

In order to confer an adherence to the food disposed on the dishware item, after having machined the upper face of the rigid plate, a material abrasion operation may be carried out at least on the machined face.

Preferably, the abrasion operation may be a sandblasting operation carried out by shot-peening.

According to another object, the invention concerns a method for manufacturing a composite material in accordance with the invention, said method comprising the steps consisting in:
depositing a rigid plate constituted essentially of a food-grade epoxy resin or a methyl polymethacrylate in a mold adjusted to the dimensions of said plate;
heating said plate in the mold to a temperature comprised between 100° C. and 150° C. for a determined period of time;
applying, in the mold, tightly on the free surface of said plate, a fluid layer of an opaque epoxy resin;
heating to a temperature comprised between 100° C. and 150° C. for a determined period of time.

Advantageously, the method may include a step of material abrasion of the free surface of the plate, after unmolding of the set.

Finally, the invention concerns a method for manufacturing a decorative object or a dishware item, including a step of cutting the composite material obtained by implementing a manufacturing method according to the invention.

### BRIEF DESCRIPTION OF THE DRAWINGS

Other advantages and features of the invention will appear better upon reading the description of a preferred embodiment which will follow, with reference to the appended drawings, made as indicative and non-limiting examples and in which:

FIG. 1a is a top view of a dishware item in accordance with the invention, said item being in the form of a flat dish;

FIG. 1b is a sectional view according to A-A of the dishware item according to FIG. 1a;

FIG. 2a is a top view of a dishware item in accordance with the invention, said item being in the form of a bowl;

FIG. 2b is a sectional view according to B-B of the dishware item according to FIG. 2a;

FIG. 3a is a top view of another embodiment of a dishware item in accordance with the invention, said item being in the form of a cutting board or a tray;

FIG. 3b is a sectional view according to C-C of the dishware item according to FIG. 3a;

FIGS. 4a to 4d illustrate different steps of the method for manufacturing a dishware item in accordance with the invention;

FIGS. 5a to 5d illustrate different steps of another method for manufacturing a dishware item in accordance with the invention;

FIGS. 6a to 6d illustrate different steps of still another method for manufacturing a dishware item in accordance with the invention.

### DETAILED DESCRIPTION

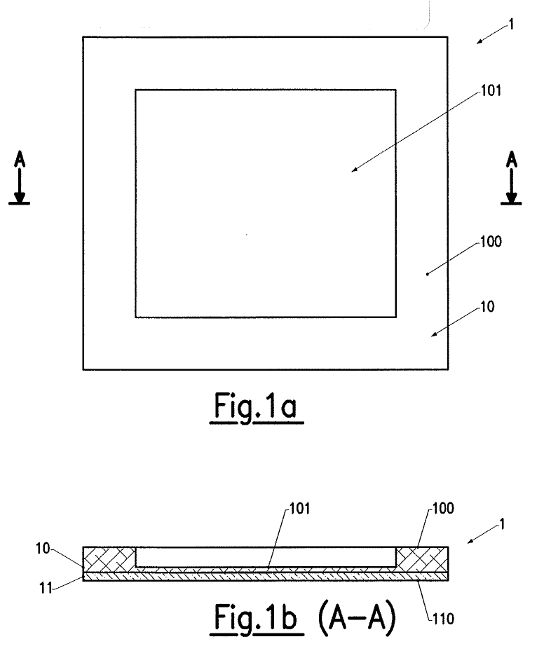

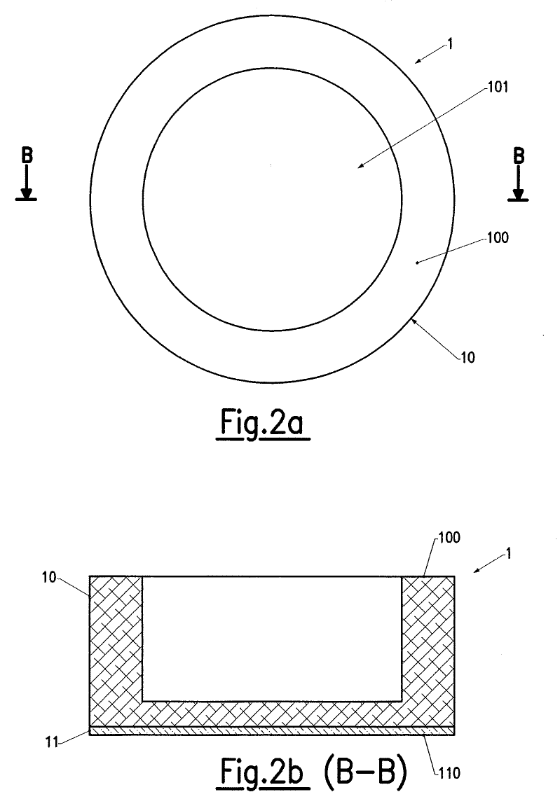

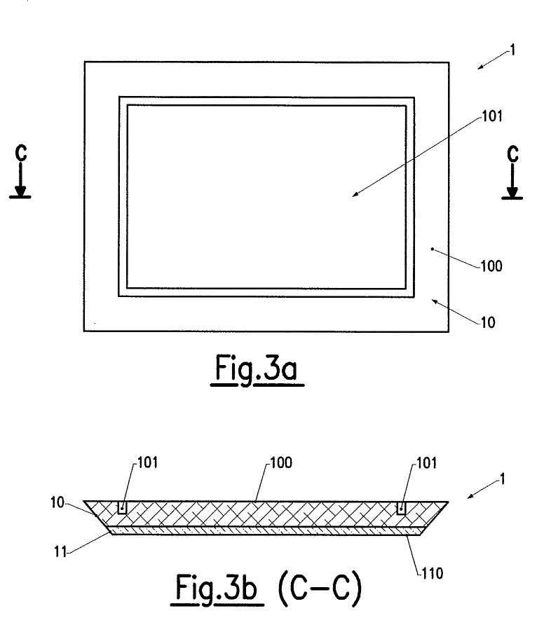

The dishware item, object of the invention, is intended to contain products intended for human nutrition. It may present a generally square shape (FIG. 1a), a round shape (FIG. 2a), a rectangular shape (FIG. 3a), an oval shape, or the like, and it may be thin (FIGS. 1a and 3a), thick (FIG. 2a), etc. it cannot be limited to these sole shapes.

Referring to the examples illustrated in the appended figures, the dishware item 1 comprises two rigid layers 10 and 11 forming a one-piece set. Advantageously, they may be welded or fastened to each other by any means.

The first layer, called the upper layer, 10 presents a face 100, including one or several hollow form(s) 101, for receiving and retaining the food. In practice, the face 100 is planar but it may be concave, convex, serrated, etc. It is sized so as to contain one or several portion(s) or several pieces such as petits fours, skewers, mini-cakes or the like.

FIGS. 1a to 3b illustrate different examples of models of dishware items. In FIGS. 1a and 1b, the item 1 is, for example, in the form of a flat dish the receiving face 100 of which comprises a square cavity 101, the sides of which have dimensions comprised between one hundred millimeters and two hundred millimeters, and the depth of which is comprised between one millimeter and twenty millimeters. In FIGS. 2a and 2b, the item 1 consists of a cylindrical bowl the face 100 of which is provided with a cylindrical cavity 101 having an inner diameter comprised between fifty millimeters and one hundred millimeters to two hundred millimeters, and the depth of which is comprised between fifty millimeters and one hundred and fifty millimeters. In FIGS. 3a and 3b, the item 1 is a rectangular plate or tray, the planar receiving face 100 of which is delimited by a rectangular channel 101, allowing recovering a juice or a sauce. Of course, other models such as cups, saucers, glasses, or others may be considered. Advantageously, the first upper layer 10 may include no cavities or no hollow forms.

The lower layer 11 presents an underside 110 forming a base. When the item 1 is used and laid on a table or any other similar support, it is the underside 110 which is contact with the latter. Preferably, the underside 110 is planar for a better holding, but a non-planar, for example a convex, shape may be considered.

In practice, and in order to simplify the design of the item 1, the two rigid layers 10 and 11 present the same contour. Nonetheless, and as is apparent in FIG. 3b, the edges of the item 1 may be beveled by an angle ranging from twenty to forty-five degrees so as to facilitate the gripping of said item when it is laid on a table.

The upper layer 10 is constituted essentially of a food-grade epoxy resin or a food-grade methyl polymethacrylate (hereinafter PMMA). By <<constituted essentially>>, is meant that the first layer 10 comprises more than 90%, advantageously more than 95%, and preferably more than 99%, by weight, of food-grade epoxy resin or food-grade PMMA. In accordance with the invention, the constitutive material of the first layer 10 is colorless and translucent or transparent. Very good results are obtained when the used material has a refractive index comprised between 1.3 and 1.6 advantageously about 1.5.

The lower layer 11 is constituted essentially of an epoxy resin. This resin is not necessarily a food-grade resin since said layer 11 is not intended to be in contact with the food. Nonetheless, it is possible to use an epoxy resin similar to that of the first layer 10, but containing pigments, for example pigments used for paints, so as to color it and make it opaque. By <<constituted essentially>>, is meant that the second layer 11 comprises more than 90%, advantageously more than 95%, and preferably more than 99%, by weight, of epoxy resin.

Advantageously, the layer 10 has a thickness greater than or equal to three millimeters. The layer 11 is less thick, the latter being however advantageously greater than or equal to one millimeter. Very good results are obtained when the layer 10 has a thickness greater than or equal to three millimeters, and the layer 11 has a thickness smaller than two millimeters. These proportions, combined with the arrangement of the different layers and with the characteristics of the used materials, act in synergy so that the ambient light can pass through the layer 10 and reflect on the layer 11, which reflection generates a visual effect such as the food seems to be in levitation.

In order to enable a better hooking of the food on the upper layer 10, ensure a stability of the food on the item, and therefore allow <<head chefs>> to lay out dishware items unevenly beforehand, the upper layer 10 is advantageously an anti-slip surface. Advantageously, such an anti-slip surface may be created by proceeding to a material abrasion operation, which gives a frosted effect to the item 1. The food barely slip and the levitation effect is therefore amplified. Such a material abrasion operation may be carried out by sanding or polishing. Preferably, it is performed by sandblasting, said sandblasting being carried out by shot-peening. Thus, the face 100 may not necessarily include hollow forms or cavities, due to the adherence conferred by the anti-slip surface of the upper layer 10 of the item 1.

Methods for manufacturing the composite material and the dishware item, objects of the invention will now be described in more detail.

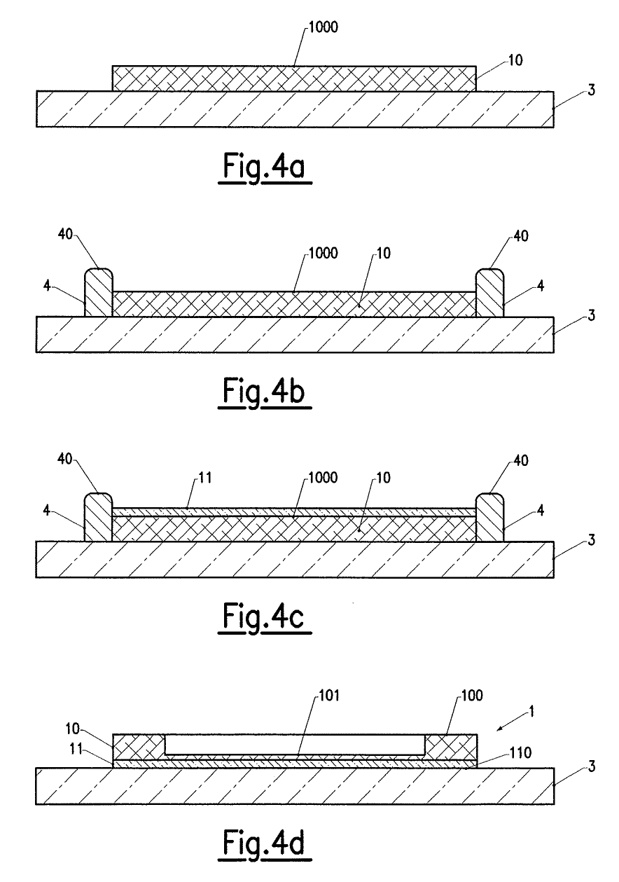

A first manufacturing method is illustrated in FIGS. 4a to 4d. We start by cutting, according to the desired final contour of the item 1, a rigid plate 10 constituted essentially of a food-grade epoxy resin or a methyl polymethylacrylate. In practice, this plate 10 has a thickness greater than or equal to three millimeters, but is also colorless and translucent. Cutting is performed by a known technique, for example saw cutting, hot-wire cutting, laser cutting, water-jet cutting. For example, the plate 10 is advantageously cut to the dimensions ranging from sixty millimeters to three hundred millimeters in order to realize dishes or bowls, and from eighty millimeters to one thousand millimeters in order to realize plates or trays. Alternatively, this cutting step may be advantageously carried out after obtaining the composite material according to the invention.

The cut plate 10 is laid on a rigid support 3 (FIG. 4a). A formwork 4 is then applied tightly against the contour of the plate 10 (FIG. 4b). This formwork 4 presents borders 40 which exceed the free surface 1000 of the plate 10. In order to simplify its laying and optimize tightness, the formwork 4 is flexible. It consists of an adhesive strip or a silicone strip which can easily adapt to the contours of the plate 10. Nonetheless, a rigid mold, made for example of metal or plastic, may be used.

A fluid layer 11 of an epoxy resin, opaque and colored beforehand, is cast on the free surface 1000 of the cut plate 10 (FIG. 4c). This resin is cast in an unpolymerized state over a thickness greater than or equal to one millimeter, preferably over a thickness smaller than two millimeters. This step is carried out at ambient temperature, without necessarily heating the resin 11 beforehand and without any other intervention, whether it is, as non-limiting examples, sanding, use of a solvent, washing. It is to be noted that the plate 10 allows ensuring a perfect flatness of the surface 1000 on which the resin 11 is cast.

After polymerization of the resin, a one-piece item 1 is obtained, formed of a rigid layer 11 of epoxy resin assembled to the rigid plate 10. The Applicant has noticed that the cohesion of the two layers was improved when the resin 11 has been mixed beforehand with a composition containing acetone and/or toluene before being cast.

Once polymerized, the rigid item 1 is turned over. The translucent upper face 100 of the plate 10 is machined so as to obtain hollow forms 101 allowing receiving and retaining food (FIG. 4d). Machining is carried out by means of machines commonly used in the industry such as numerical-control machines. This machining step is optional.

Alternatively or complementarily to the machining of the upper face 100, it may be advantageous to proceed to a material abrasion operation, in order to give a frosted effect to the item 1 and to form anti-slip surfaces avoiding slipping of said item and food. This finishing operation is carried out at least on the machined face 100 and may also be advantageously performed on the underside 110 forming a base. Preferably, it consists of a sandblasting operation or a shot-peening operation.

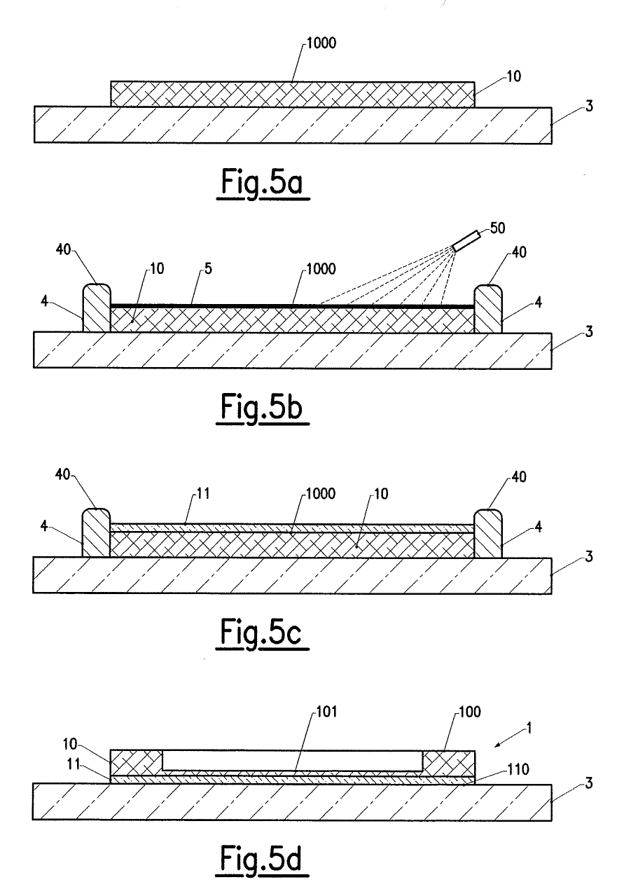

The method illustrated in FIGS. 5a to 5d comprises a series of steps similar to those described before. Nonetheless, as is apparent in FIG. 5b, a composition 5 containing acetone and/or toluene is applied beforehand on the free surface 1000 of the plate 10, before casting the epoxy resin 11. This application is performed by means of a spray 50 or a brush, and aims to improve the cohesion between the two layers 10 and 11. In this case, it is not necessary to mix another composition containing acetone and/or toluene with the resin 11, before casting.

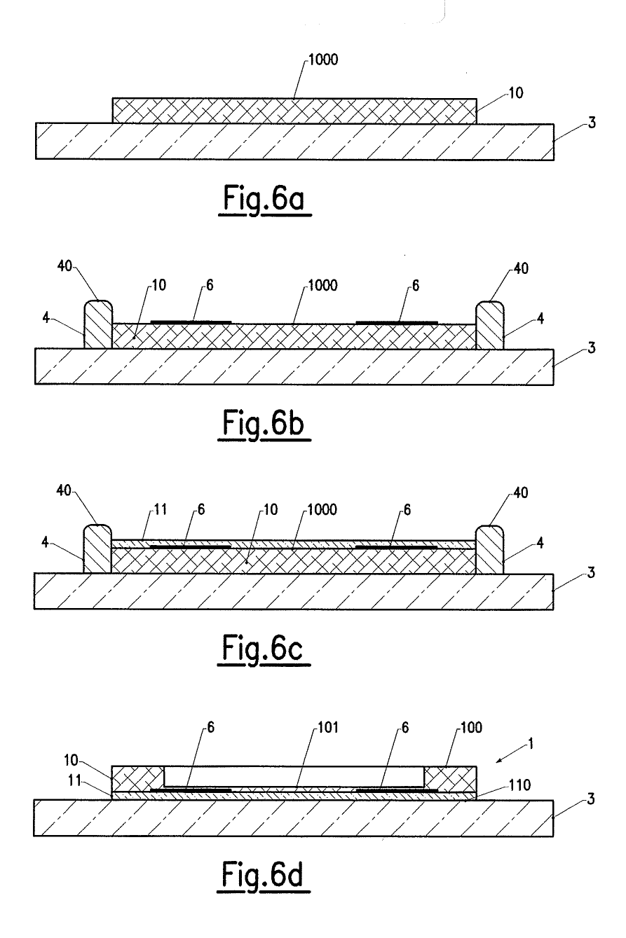

The method illustrated in FIGS. 6a to 6d is similar to those described previously with reference to FIG. 4a to 4d, or 5a to 5d. One or several decorative element(s) 6, such as, as non-limiting examples, screen printings, objects, letters, drawings, or still photos, are arranged on the free surface 1000 of the plate 10 before casting the resin 11. Nonetheless, the surface occupied by the items 6 is smaller than that of the free surface 1000, advantageously smaller by 50%, so as not to disturb the visual effect mentioned before in the description. This type of inclusion allows customizing the item 1.

In one variant, after casting the epoxy resin 11 on the plate 10, the <<plate 10—resin 11>> set is heated to a temperature comprised between 130° C. and 150° C. for a period comprised between 5 min and 20 min. For example, this set may be inserted in a drying-oven device properly adjusted. This vulcanization technique allows creating cohesion between the two materials which makes the dishware item 1 particularly resistant and hardly breakable.

Moreover, a second manufacturing method may be used. Such a second manufacturing method also comprises a series of steps similar to those described previously. Nonetheless, instead of cutting a rigid plate 10 constituted essentially of a food-grade epoxy resin or a methyl polymethylacrylate, a formwork 4 is applied tightly against the contour of the uncut plate 10. As described before, this formwork 4 presents borders 40 which exceed the free surface 1000 of the plate 10. In order to simplify its setting and optimize tightness, the formwork 4 may be flexible. It may consist of an adhesive strip or a silicone strip, which can easily adapt to the contours of the plate 10. Still, for this particular manufacturing method, a rigid mold, made for example of metal or plastic, may be preferably used. Advantageously, such a formwork 4 may be adjusted to the dimensions of the uncut plate 10. After having been inserted in said mold or formwork, the rigid plate 10 is placed in an adapted and properly adjusted heating device. Several rigid plates 10 contained in their respective formworks 4 may be positioned simultaneously in the same drying-oven device. This heating step enables a <<softening>> of the rigid plate, since the melting point of the rigid plate is of about 120° C.

After a few minutes, advantageously about ten minutes, in a heating device pre-heated to a temperature comprised between 100° C. and 150° C., a fluid layer 11 of epoxy resin, opaque and possibly colored beforehand, is cast tightly on the free surface 1000 of the uncut plate 10 placed in the mold. This resin is cast in an unpolymerized state over a thickness greater than or equal to one millimeter, preferably over a thickness smaller than two millimeters.

Then, the set is heated again in a drying oven to a temperature comprised between 100 and 150° C. for ten to fifteen minutes: this vulcanization step allows creating a hooking between the two layers and ensures the proper cohesion of the set so as to constitute a composite material according to the invention.

Once the set is dry and cold, the method may include a step of screen printing patterns, letters or signatures, for example.

Moreover, the method includes a material abrasion operation carried out on the plate 10 of the material, in order to give a frosted effect to the composite material and to form anti-slip surfaces. Preferably, it consists of a sandblasting operation or a shot-peening operation.

Finally, the composite material is turned over, and is then cut thanks to conventional techniques, such as, as non-limiting examples, saw cutting, hot-wire cutting, laser cutting, water-jet cutting, etc.

Complementarily, the method may further include a step of laying a food-grade varnish on either one of the faces of the obtained composite material.

1. A composite material, the material including two rigid layers: an upper layer presenting a face and a lower layer presenting an underside forming a base, wherein:
the upper layer has a thickness greater than or equal to three millimeters and is constituted essentially of a food-grade epoxy resin or a food-grade methyl polymethacrylate, said resin or said polymethacrylate being colorless and translucent;
the lower layer has a thickness greater than or equal to one millimeter, still smaller than the thickness of the first layer, and is constituted essentially of an opaque epoxy resin; and
the two layers cooperate with each other and form a one-piece item.

2. The composite material according to claim 1, wherein the opaque epoxy resin is colored.

3. The composite material according to claim 1, wherein the face of the upper layer is an anti-slip surface.

4. The composite material according to claim 1, wherein the upper layer has a thickness greater than or equal to three millimeters and the lower layer has a thickness smaller than two millimeters.

5. The composite material according to claim 1, wherein the upper layer has a refractive index comprised between 1.3 and 1.6.

6. The composite material according to claim 1, wherein an intermediate layer including decorative elements is inserted between the lower and upper layers.

7. A dishware item for containing food, the dishware item being developed from a composite material according to claim 1.

8. The dishware item according to claim 7, the dishware item being in the form of a dish, a bowl, a plate or a tray.

9. The dishware item according to claim 7, including one or several hollow form(s).

10. A decorative object developed from a composite material according to claim 1.

11. A method for manufacturing a dishware item in accordance with claim 7, the method comprising the steps consisting of:
cutting, according to a desired contour, a rigid plate constituted essentially of a food-grade epoxy resin or a food-grade methyl polymethacrylate, said plate having a thickness greater than or equal to three millimeters and being colorless and translucent;
laying the cut plate on a rigid support and applying a formwork tightly against the contour of the plate, said formwork presenting borders which exceed the free surface of the plate;
casting, on the free surface of the cut plate, and over a thickness greater than or equal to one millimeter, an unpolymerized fluid layer of an opaque epoxy resin;
leaving the layer of opaque epoxy resin polymerize until obtaining a one-piece item formed by a rigid layer of opaque epoxy resin welded to the rigid plate.

12. The method according to claim 11, including a step consisting in machining the upper face of the rigid plate so as to obtain hollow forms allowing receiving and retaining food.

13. The method according to claim 11, wherein, before casting the opaque epoxy resin, a flexible formwork is applied tightly against the contour of the cut plate.

14. The method according to claim 11, wherein a composition containing acetone and/or toluene is mixed with the epoxy resin before casting on the free surface of the cut plate.

15. The method according to claim 11, wherein a composition containing acetone and/or toluene is applied on the free surface of the cut plate before casting of the opaque epoxy resin.

16. The method according to claim 11, wherein, after casting of the opaque epoxy resin, the set composed of the rigid plate and of the layer of opaque epoxy resin is heated to a temperature comprised between 130° C. and 150° C. for a period comprised between 5 min and 20 min.

17. The method according to claim 11, wherein one or several decorative element(s) are arranged on the free surface of the cut plate before casting the opaque epoxy resin, the surface occupied by said decorative elements being smaller than that of the free surface.

18. The method according to claim 12, wherein, after having machined the upper face of the rigid plate, a material abrasion operation is carried out at least on the machined face and on the colored and opaque epoxy resin underside forming a base.

19. The method according to claim 18, wherein the abrasion operation is a sandblasting operation or a shot-peening operation.

20. A method for manufacturing a composite material in accordance with claim 1, the method comprising the steps consisting of:
depositing a rigid plate constituted essentially of a food-grade epoxy resin or a methyl polymethacrylate in a mold adjusted to the dimensions of the plate;
heating said plate in the mold to a temperature comprised between 100° C. and 150° C. for a determined period of time;
applying, in the mold, tightly on the free surface of said plate, a fluid layer of opaque epoxy resin;
heating to a temperature comprised between 100° C. and 150° C. for a determined period of time.

21. The method according to claim 20, including a step of material abrasion of the free surface of the plate, after an unmolding of the set composed of the rigid plate and of the opaque epoxy resin.

22. A method for manufacturing a decorative object or a dishware item, including a step of cutting the composite material obtained by implementing a manufacturing method according to claim 20.
